(19) United States
(12) Patent Application Publication
(10) Pub. No.: US 2002/0000401 A1
(43) Pub. Date: Jan. 3, 2002

(54) Dry physical separation of particulate material

(75) Inventors: Maureen Teresa O'Connor, Brisbane (AU); John Michael Frederick Clout, Brisbane (AU); John Francis Gannon, Sydney (AU); Keith Russell Weller, Brisbane (AU)

Correspondence Address: JACOBSON HOLMAN PLLC, 400 SEVENTH STREET N.W., SUITE 600, WASHINGTON, DC, 20004, US

(73) Assignee: COMMONWEALTH SCIENTIFIC AND INDUSTRIAL RESEARCH ORGANIZATION

(21) Appl. No.: 09/938,595

(22) Filed: Aug. 27, 2001

Related U.S. Application Data
(63) Continuation of application No. 09/147,674, filed on Apr. 29, 1999, now abandoned.
Application No. 09/147,674 is a 371 of international application No. PCT/AU97/00507, filed on Aug. 11, 1997.

(30) Foreign Application Priority Data
Aug. 12, 1996 (AU) P01569

(51) Int. Cl. B07C 9/00; B07B 13/00

(52) U.S. Cl. 209/691; 209/694; 209/481

(57) ABSTRACT

An apparatus for dry physical separation of particulate material comprises an inclined separating surface having upper and lower edges, oscillation means for inducing non-linear oscillatory motion of the separating surface, and introduction means for introducing the particulate material onto the separating surface between the upper and lower edges.

### TECHNICAL FIELD

Particulate material can be separated by a variety of techniques which can be broadly classified as wet techniques and dry techniques. Wet techniques can be used in cases where water is required for subsequent processing. However, were that is not the case, the introduction of water into a separation process is undesirable because it drastically increases costs associated with materials handling, thickening, filtration, drying etc.

The present invention relates to a apparatus and a method for the dry physical separation of particulate material but it is to be understood that the present invention may be used for the separation of moist or damp material. The apparatus and method have application in dry physical separation for both beneficiation and size classification.

The present invention has particular, although not exclusive, application to the separation of particulate material in the mining and related industries. The value of some particulate materials, for example, crushed rock, metalliferous ores or, coal may be substantially enhanced by the removal of particles deleterious to subsequent treatment processes. In the case of iron ores comprising a mixture of rock and mineral types, removal of only a modest amount of deleterious particles by a dry physical process could substantially enhance their value or marketability. In the case of some quarry products, use of a dry physical separation process could convert a substantial proportion of large waste dumps into a marketable product.

### BACKGROUND ART

Convectional dry separation techniques exploit differences in physical properties of particles such as disc, shape and density, magnetic and electrostatic properties.

Dry separation by size and by shape is normally carried out on screens when the separating size lies between about 150 mm and 1 mm. Below about 4 mm dry screening becomes difficult, particularly in the presence of moisture, with capacity falling and it becomes more difficult to achieve good separation efficiency.

Dry separation by size and specific gravity can be achieved by use of different settling velocities in air of particles of different size and specific gravity. Such techniques are referred to as classification techniques and are conventionally used to separate particles in the size range from about 100 μm down to about 10 μm. Rotating vane classifiers and air cyclones are examples of devices which utilise classification techniques. Such devices have limitations because they can not be used for moist materials, they have low throughput, and they only provide a fixed cut size.

Differences in frictional properties have been proposed as a basis for a dry separation technique. SU 1315875 teaches an apparatus for the separation of free-flowing materials such as plant seeds. The apparatus has an inclined vibro-table which is subjected to linear vibration in the plane of the table. Seeds are placed on the vibro-table surface with rougher, plain and less elastic seeds said to move up the vibro-table and mature seeds said to move down the vibro-table. SU 1315875 teaches suppression of rolling motion US 5069346 teaches a process by which a mixture of two or more discrete particulate materials having different sliding coefficients of friction can be separated using a method which takes advantage of velocity differences generated by the application of a force to the mixture to create movement of the mixture over a surface. One embodiment teaches a vibratory table apparatus which is subjected to a linear cyclical motion imparted to the deck of the vibratory table in the plane of the deck. Beneficiation is achieved through differences in frictional properties between ore and gangue minerals with the apparatus being arranged to maintain maximum frictional contact between the vibratory table and the particulate material throughtout the separation process.

It is believed that no dry separation technique based on differences in frictional properties of particulate material has been commercialised.

### DISCLOSURE OF THE INVENTION

In a first aspect, the present invention provides an apparatus for dry physical separation of particulate material, the apparatus comprising:

an inclined separating surface having upper and lower edges,

oscillation means for inducing non-linear oscillatory motion of the separating surface, and

introduction means for introducing the particulate material onto the separating surface between the upper and lower edges.

In a second aspect, the present invention provides a method for dry physical separation of particulate material, the method comprising the steps of:

inducing non-linear oscillatory motion of an inclined separating surface having upper and lower edges, and

introducing the particulate material onto the separating surface between the upper and lower edges

whereby a first portion of the particulate material moves upwardly towards the upper edge and a second portion of the particulate material moves downwardly towards the lower edge.

In use, the non-linear oscillatory motion of the separating surface “throws” the particulate material up the separating surface towards the upper edge whilst gravity provides a counter-current force in the direction of the lower edge. Different particles within the particulate material behave differently when they make contact again with the separating surface. Separation is believed to occur as a consequence of coarser particles bouncing and rolling down the separating surface towards its lower edge a finer particles progressively moving up the separating surface by bouncing, sliding and being thrown until they pass over the upper edge of the separating surface. High speed filming indicates that being thrown towards the upper edge of the separating surface whilst not in contact with the separating surface is the most significant manner by which fine particles move up the separating surface. Separation is believed to be added by the lower rolling coefficient of friction combined with the higher sliding coefficient of friction of finer particles. In moving up the separating surface, it is to be appreciated that particles may move slightly down the separating surface prior to subsequently moving up the separating surface and thus the upwards movement may consist of a series of incremental upwards movements. In moving up the separating surface it is to be noted that individual particles tend to approach one another to form loose aggregates of particles which are thrown up the separating surface more quickly than individual particles. This phenomenon can be visualised as being similar to individual droplets of rain on a window pane meeting and forming a stream which moves down the window pane more quickly than an individual droplet.

Separation according to the present invention is believed to be largely independent of particle shape and manipulation of a number at variables which are referred to below can modify the cut point at which size separation occurs. Size separations from 1 mm to less than 100 μm have been achieved according to the present invention for particulate material having a free moisture content of less than 10% by weight. In the case of dry feed material, size separations with a cut size down to 30 μm have been achieved.

The non-linear oscillatory motion is preferably an elliptical or eccentric motion and the precise nature of the motion affects the degree to which particles are thrown up the separating surface which in turn affects the extent of particle sliding and/or bouncing, the cut size (particle size an which 50% of the feed material reports both to the coarse and the fine products), the separation efficiency and the speed of particle transport. The inclined separating surface is preferably supported by a base which is preferably mounted on or supported by springs. The preferred elliptical motion can be induced by way of a variable speed motor driving a standard out of balance flywheel with the base being weighted so as to modify the circular motion which would otherwise be induced. Alternatively, the motion may be induced by imparting two or more non-parallel but linear motions whereby the resultant net motion is a non-linear oscillatory motion. In some situations, it has also been found to be desirable to facilitate a secondary motion of the separating surface such that the motion is not, for example, purely elliptical. Such secondary motion can be induced by mounting the separating surface such that some movement is possible between the separating surface and its mounting base. Alternatively secondary motion can be induced by use of an additional variable speed motor which imparts a linear motion at an angle to the axis of the non-linear oscillatory motion. Advantageously, an apparatus according to the present invention can be made by modification of conventional pieces of classification/beneficiation equipment.

The separating surface may be of any convenient shape but is preferably planar and rectangular. The separating surface preferably takes the form of a deck which may be formed from a variety of materials with different materials being desirable in different circumstances. Separating surfaces having very low frictional coefficients are desirable for sharp and fine size separation whereas, the size separation of particles which have smooth round surfaces is better facilitated on a separating surface which is rough and abrasive. Further, the separating surface can be selected to enhance bouncing and rolling behaviour of particles. Preferably; the separating surface is formed from an industrial wear resistant material such as a metallic or plastics material. For example, the separating surface may be formed from polyethylene, natural or synthetic rubber, coated polyurethane and chrome steel alloys.

The frequency and amplitude of the non-linear motion are preferably independently variable with optimum frequency and amplitude being dependent upon the type of particulate material and its moisture content. Increased frequency tends to decrease the particle size at which separation occurs for moist particulate materials. Increased amplitude tends to increase bouncing and rolling of coarser particles resulting in finer and sharper size separations for both moist and dry particulate materials.

The angle of inclination of the separating surface is preferably variable. The angle of inclination may be determined prior to operation or may be modified during operation. The steeper the inclination of separating surface, the more difficult it is for particles to move up the separating surface with the result that increased inclination favours the upward movement of smaller particles having higher sliding and lower rolling coefficients of friction. Increasing the angle of inclination therefore tends to decrease the cut size of the separation and produce a finer product. The angle of inclination is preferably in the range of 1-20° and will typically be in the range of 10-15°; however, it is to be understood that angles of inclination outside these ranges fall within the scope of the present invention.

A plurality of separating surfaces can be arranged to be used in series in accordance with the present invention. For example, particulate material may be introduced to a first separating surface with the coarse or fine material collected from the lower and upper edges respectively of the separating surface being introduced to another separating surface arranged to provide either improved separation at the same particle size or further separation at a different particle size. Each of the plurality of separating surfaces may form a component of a separate apparatus according to the present invention. Preferably however, the plurality of separating surfaces are mounted on a common base and thereby form components of a single piece of apparatus. It will therefore be appreciated that an apparatus according to the present invention can be used to separate a feed of particulate material into various fractions with the size ranges of the particles in the various fractions being variable.

The introduction means for introducing the particulate material onto the separating surface can take a variety of forms but is preferably a vibratory, belt or screw feeder which preferably introduces the particulate material as a uniform curtain across the width of the separating surface.

As previously mentioned, the present invention relates to a dry physical separation technique but can be used for separation of moist or damp particulate material. Where particulate material is moist, the effective size of the separation tends to be increased, as compared with a dry sample of the same material, because particles tend to stick together to behave as larger particles. The presence of moisture also tends to alter the coefficient of friction of a particle. A moist sample of particulate material tends to be separated at a coarser size as compared with a dry sample of the same material. However, increasing frequency tends to break up the larger particles and therefore decreases the size as which separation occurs.

Preferred embodiments of the present invention will now be described by way of example only with reference to the accompanying drawing, in which:

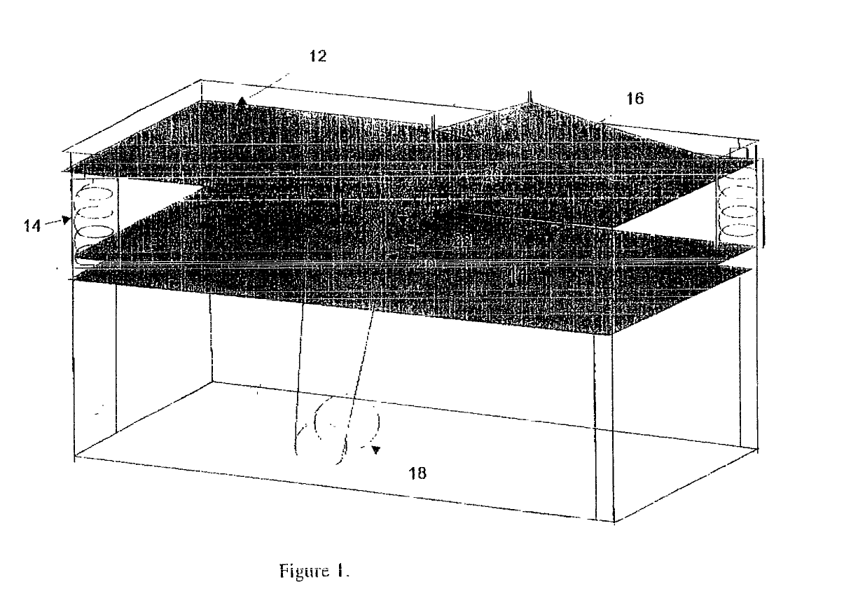

FIG. 1 is a schematic representation of an apparatus according to the present invention;

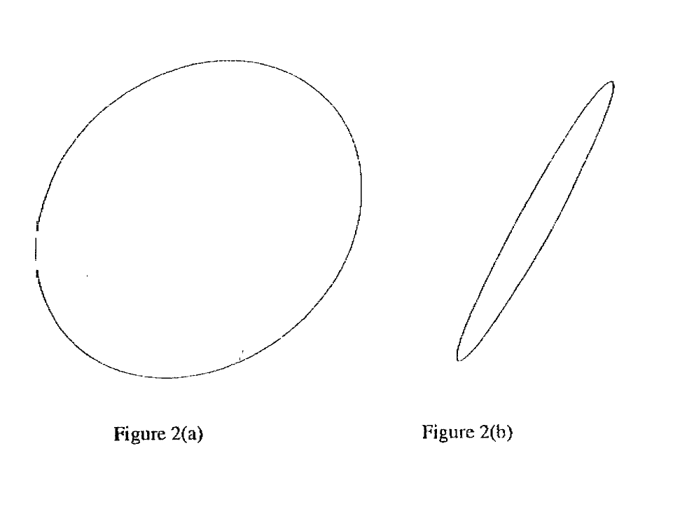

FIGS. 2(a) and 2(b) are representations of non-linear oscillatory motion;

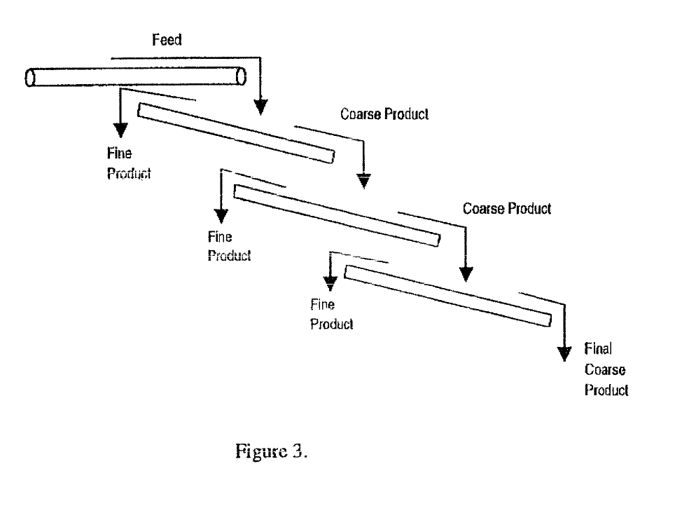

FIG. 3 is a schematic representation of a series of three separating surfaces which are mounted on a common base of the apparatus of FIG. 1;

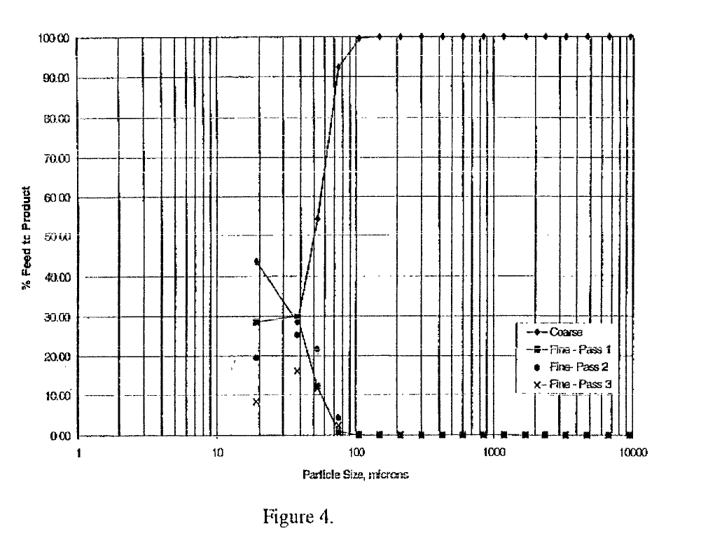

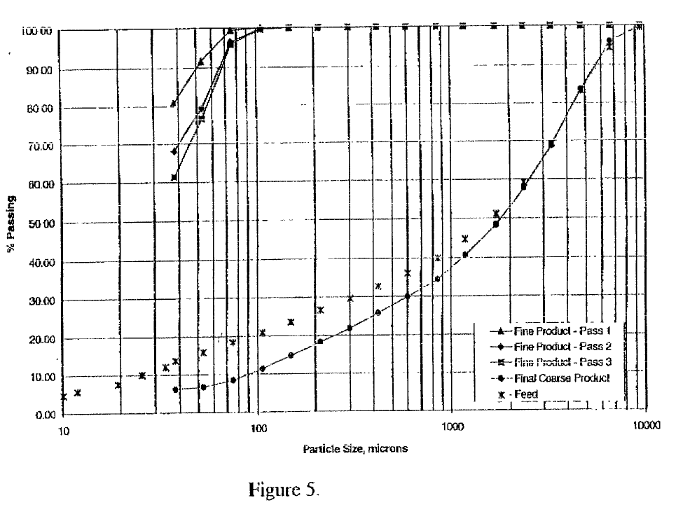

FIGS. 4 and 5 are plots of size separation efficiency and particle size distributions respectively of a simple of iron ore in which an apparatus according to FIG. 3 was used;

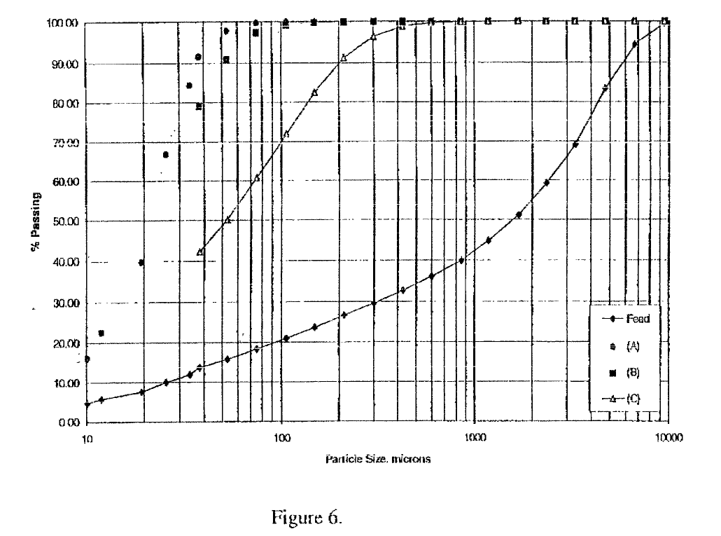

FIG. 6 is a comparative plot of identical samples of iron ore processed by the apparatus of FIG. 1 as compared with a piece of apparatus according to the prior art;

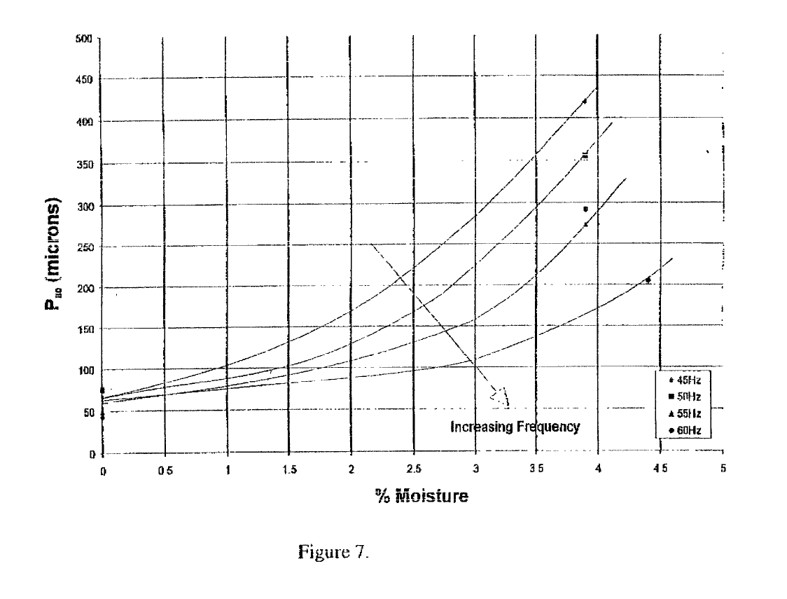

FIG. 7 is a plot of the effect of frequency on identical samples of moist iron ore processed by the apparatus of FIG. 1;

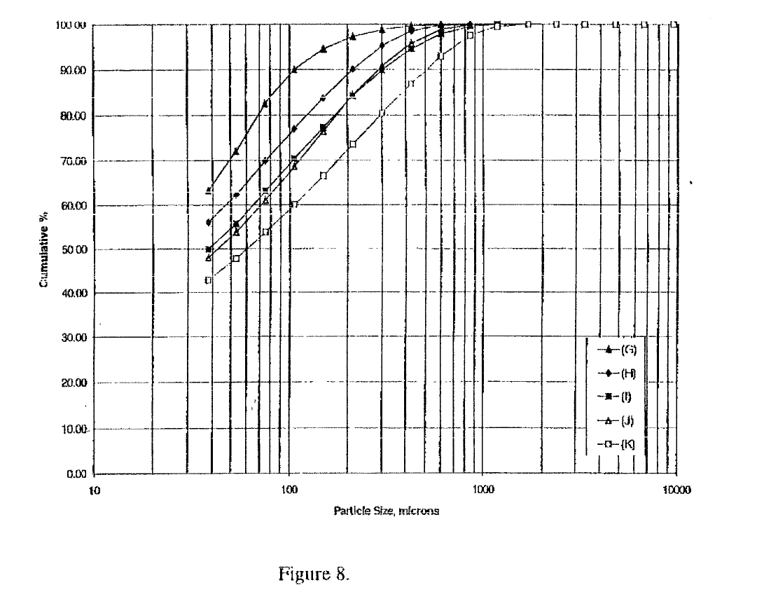

FIG. 8 is a comparative plot of the effect of feed rate on identical samples of iron ore processed by the apparatus of FIG. 1 as compared with the prior art apparatus referred to in relation to FIG. 6;

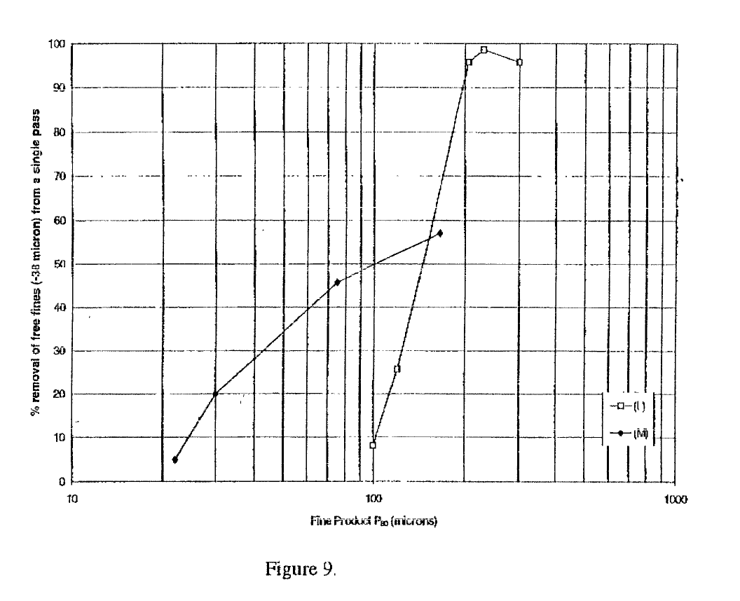

FIG. 9 is a comparative plot of fine particle separation efficiency on identical samples of iron ore processed by the apparatus of FIG. 1 as compared with the prior art apparatus referred to in relation to FIG. 6; and

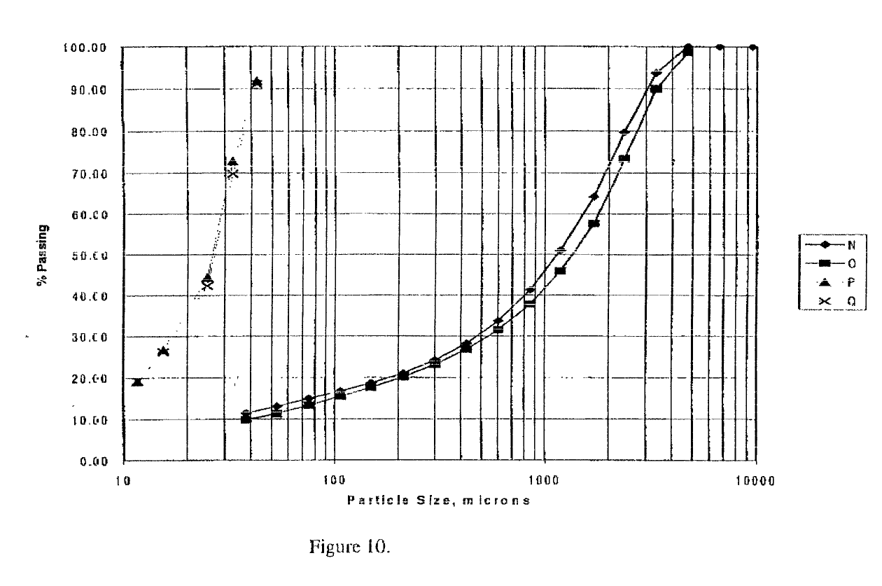

FIG. 10 a plot of particle size distributions of a sample of quarry dust in which an apparatus according to FIG. 3 was used.

Referring firstly to FIG. 1 the apparatus 10 was made by modification to a standard Denver-Dillon screen deck and comprises a base 12 which is mounted on springs 14 and which supports a separating surface 16 in the form of a planar rectangular deck. The angle of inclination of the separating surface 16 is variable and the separating surface 16 is interchangeable with decks made of different materials. Particulate material is introduced to the separating surface 16 by introduction means (not shown) in the form of a vibratory feeder arranged to progressively introduce the particulate material as a uniform curtain across the width of the separating surface 16. Receptacles (not shown) are provided for collecting the coarser product and the fine product. The standard screen deck was modified by replacing the screens with the separating surface 16 and modifying the standard vibration motion with oscillation means for inducing non-linear oscillatory motion of the separating surface. The non-linear oscillator motion is imparted by a variable speed motor 18 driving a pair of standard out of balance flywheels 20 connected by a drive shaft 22 with the base 12 being weighted to modify the circular motion which would otherwise be induced. The nature of the non-linear oscillatory motion capable of being imparted it diagrammatically represented in FIGS. 2(a) and 2(b); FIG. 2(a) being a near circular motion and FIG. 2(b) being a rear linear motion.

FIG. 4 is a plot of the size separation efficiency of a sample of iron ore introduced to the apparatus of FIG. 3 at a feed rate of 500 kg/hour per m² of separating surface. A very sharp fine (approximately 50 μm) size separation was achieved and all free tines (less than 33 μm were removed after 3 passes over the apparatus equipped with polyethylene decks at inclinations of 15°. Each deck had a surface area of 0.9 m² and the apparatus was operated at a frequency of 50 Hz and an amplitude of 9 mm.

FIG. 5 a plot of the particle size distributions of the feed and products for a sample of iron ore introduced to the apparatus of FIG. 3 at a feed rate of 560 kg/hour per m² of separating surface. The apparats was equipped with polyethylene decks at inclinations of 15°. Each deck had a surface area of 0.09 m² and the apparatus was operated at a frequency of 50 Hz and an amplitude of 9 mm.

FIG. 6 is a comparative plot of identical samples of iron ore processed by the apparatus of FIG. 1((A) and (B)) and a prior art apparatus (C). The apparatus used in the case of (C) was similar to the teaching of the prior art with the motion induced in the deck being a linear oscillatory motion in the plane of the deck as taught by SU 1315875 and US 5069146. In (A) and (B), the inventive apparatus was equipped with a coated polyurethane deck and a polyethylene deck respectively and, in both cases, the inclination was 15°. In (C) the prior art apparatus was equipped with a painted deck at an inclination 22.2°. In all cases the deck had a surface area of 0.09 m² and the apparatus was operated at a frequency of 50Hz. For (A) and (B) the apparatus was operated at an amplitude of 9 mm and for (C) was operated at an amplitude of 5 mm. For each of (A), (B) and (C), the deck material, amplitude and inclination were selected to optimise the results in terms of size separation. As can be seen from the plot, superior results were achieved with the inventive piece of apparatus. The only difference between (A) and (B) was the choice of deck material and it is noted that the change in deck material affected the fineness of the cut.

FIG. 7 is a plot of the effect of frequency on identical sample of moist iron ore introduced to the apparatus of FIG. 1 in which the only variables were moisture connected frequency. In all cases the deck was linatex red having a surface area of 0.09 m² and an inclination of 11° and the apparatus was operated at an amplitude of 9 mm. It is to be noted that improved results for moist feed material were achieved at higher frequency.

FIG. 8 is a comparative plot of the effect of feed rate on identical samples of iron ore processed by the apparatus of FIG. 1((G), (H) and (I)) and the prior art apparatus ((J) and (K)). In all cases the apparatus was equipped with a linatex red deck having a surface area of 0.09 m² and an inclination of 11°. In all cases the apparatus was operated at a frequency 50 Hz. For (G), (H) and (I) the apparatus was operated at an amplitude of 9 mm and for (J) and (K) was operated at an amplitude of 5 mm. The feed rates per m² of separating surface for (G), (H), (I), (J) and (K) were 870 kg/hour, 1170 kg/hour, 2250 kg/hour, 500 kg/hour and 780kg/hour respectively. It is to be noted that marginally superior results were achieved with the inventive apparatus as compared with the prior art apparatus even with in excess of a four fold increase in feed rate, ie. 2250 kg/hour per m² of separating surface as compared with 500 kg/hour per m² of separating surface.

Trial (G) was video recorded at normal speed and was also filmed with a high speed camera (800 frames per second). Slow motion replay of the normal speed recording showed that coarse material virtually immediately bounced and rolled down the separating surface towards, and ultimately over, the lower edge of the separating surface with a small percentage of coarser particles initially bouncing towards the upper edge following first striking the separating surface. After a bounce or two towards the upper edge, the small percentage of coarser particles bounced and rolled rapidly towards the lower edge. The fine material appeared as a pulsating bed which progressed up the separating surface towards, and ultimately over, the upper edge of the separating surface. The progression of fine particles was more rapid in areas where the fine particles agglomerated and tended to move as an agglomerated mass. An ultra-slow motion replay (high speed filming at 800 frames per second replayed at 25 frames per second) demonstrated that the fine particles lost contact with the separating surface and then re-contacted the separating surface many times in progressing up the separating surface. The fine particles only progressed up the separating surface whilst not in contact with the separating surface. On re-contacting the separating surface, the fine particles maintained position relative to the separating surface until the next cycle of the non-linear oscillatory motion where they again left the separating surface to be propelled towards the upper edge of the separating surface. Agglomerations of fine particles were observed to more readily lose contact with the separating surface and move further through the air than individual fine particles.

FIG. 9 is a comparative plot of fine particle separation efficiency on identical samples of iron ore processed by the prior art apparatus (L) and the inventive apparatus of FIG. 1(M). In both cases the deck had a surface area of 0.09 m² and the apparatus was operated at a frequency ) of 50 Hz. For (L) the apparatus was operated at an amplitude of 5 mm and for (M) the apparatus was operated at an amplitude of 9 mm. It is to be noted that the present invention is capable of removing very fine particles (ie. below 100 μm and down to 20 μm); whereas, the prior art apparatus does not achieve a size separation below 100 μm.

FIG. 10 is a plot of the particle size distributions of the feed and products for a sample of quarry dust introduced to the apparatus of FIG. 3 at a feed rate of 570 kg/hour per m² of separating surface for the first pass and at a feed rate of 200 kg/hour per m² or separating surface for the second pass. The apparatus was equipped with a linatex red deck at an inclination of 11° to the horizontal. Each deck had a surface area of 0.09 m and the apparatus was operated at a frequency or 50 Hz and an amplitude of 9 mm. A very fine reject was produced from the feed (N) after the first pass (P) over the deck with a P₈₀ of less than 35 μm. The coarse product (C) from the first pass was subsequently passed cover the deck with the same conditions as the first pass which produced a similar fine product size distributor (Q) as the first pass (P). The size separation achieved (less then 35 μm) is significantly finer than that required for the production of manufactured sand from quarry dust (less then 75 μm). The apparatus variables can be easily optimised to perform the less difficult task of achieving the slightly coarser separation required for production of manufactured sand with improved separation efficiency and higher throughputs than are possible with conventional equipment.

1. An apparatus for dry physical separation of particulate material, the apparatus comprising:
an inclined separating surface having upper and lower edges,
oscillation means for inducing non-linear oscillatory motion of the separating surface, and
introduction means for introducing the particulate material onto the separating surface between the upper and lower edges.

2. An apparatus as claimed in claim 1 wherein the non-linear oscillatory motion is an elliptical or eccentric motion.

3. An apparatus as claimed in claim 1 or claim 2 wherein the oscillation means comprises a variable speed motor driving an out of balance flywheel.

4. An apparatus as claimed in claim 1 or claim 2 wherein the oscillation means comprises means for imparting a plurality of non-parallel linear motions.

5. An apparatus as claimed in claim 3 or claim 4 wherein the oscillation means further comprises means or imparting a linear motion at an angle to the axis of the non-linear oscillatory motion.

6. An apparatus as claimed in any one of the preceding claims wherein the separating surface is mounted on a base which is mounted on or supported by springs.

7. An apparatus as claimed in claim 6 wherein the separating surface is arranged for limited movement relative to the base.

8. A apparatus as claimed in any one of the preceding claims wherein one or more of the frequency of the non-linear oscillatory motion, the amplitude of the non-linear oscillatory motion and the angle of inclination of the separating surface are variable.

9. An apparatus as claimed in any one of the preceding claims wherein the separating surface is inclined at an angle of 1-20°.

10. An apparatus as claimed in claim 9 wherein the separating surface is inclined at an angle of 10-15°.

11. An apparatus as claimed in any one of the preceding claims wherein the apparatus has a plurality of separating surfaces arranged for use in series.

12. A method for dry physical separation of particulate material, the method comprising the steps of:
inducing non-linear oscillatory motion of an inclined separating surface having upper and lower edges, and
introducing the particulate material onto the separating surface between the upper and lower edges
whereby a first portion of the particulate material moves upwardly towards the upper edge and a second portion of the particulate material moves downwardly towards the lower edge.
